(19) United States
(12) Patent Application Publication
(10) Pub. No.: US 2007/0047404 A1
(43) Pub. Date: Mar. 1, 2007

(54) AUXILIARY METHOD FOR TRACK SEEKING IN AN OPTICAL DRIVE

(76) Inventors: An-Te Liu, Taoyuan County (TW); Shang-Hao Chen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/466,106

(22) Filed: Aug. 22, 2006

(30) Foreign Application Priority Data
Aug. 25, 2005 (TW) 094129187

(51) Int. Cl. G11B 19/00

(52) U.S. Cl. 369/47.4

(57) ABSTRACT

An auxiliary track seeking method includes detecting a deviation signal corresponding to a positional difference between a fine actuator and a coarse actuator; judging a track seek direction; determining if the deviation signal is greater than a deviation threshold value; detecting whether a number of times of applying a voltage pulse is less than a predetermined number; applying the voltage pulse to push the coarse actuator and thereby adjust the deviation signal toward the deviation threshold value, a time duration and an amplitude of the voltage pulse being predetermined as fixed or variable; accumulating the number of times of applying the voltage pulse; repetitively exerting the voltage pulse until the deviation signal value reaches the deviation threshold value; and resetting the accumulated number of times of exerting the voltage pulse to zero and then ending the tracking seeking to thereby reduce track seeking failures.

### BACKGROUND OF THE INVENTION

1. Field of the Invention

The invention relates to optical drives, and more particularly, to an auxiliary method of track seeking to improve performance when searching for a track in an optical drive.

2. Description of the Prior Art

Please refer to FIG. 1 showing a block diagram of how a conventional optical drive controls a fine actuator 12 and a coarse actuator 11. In order to read an optical disc, the conventional optical drive utilizes the coarse actuator 11 to pull the fine actuator 12. The coarse actuator 11 is controlled from a direct current (DC) motor known as a sled motor 13 and a screw, and the feeding range of the coarse actuator 11 is greater than the fine actuator 12. The fine actuator 12 is coupled to the coarse actuator 11 to thereby create an actuator unit. Normally, the fine actuator is adjusted by a voice coil motor and has a smaller feeding range. According to a tracking error detected by a tracking-error detecting unit 14, a control unit 15 respectively utilizes a fine drive circuit 16 and a coarse drive circuit 17 to drive the fine actuator 12 and the coarse actuator 11 to lock onto an information track of the optical disc. When performing track seeking operations, the coarse actuator 11 carries the fine actuator 12 while performing the large distance portion of the seeking operation to arrive in the vicinity of the target track. Afterwards, the fine actuator 12 performs fine track seeking over a few tracks to thereby lock onto the target track.

While the fine actuator 12 is performing fine track seeking over a few tracks, often the fine actuator 12 will already be near an edge of the coarse actuator 11 before the track seeking operation was started. In this case, the fine actuator 12 may need to perform track seeking in the same direction near the end and thereby arrive at the edge of the coarse actuator 11. Because it is not possible to maintain perfect signal quality at the edge, such a situation results in a failure of the track seeking operation. Because conventional optical drives do not check the relative positions of the coarse actuator 11 and the fine actuator 12 before performing a track seeking operation, the fine actuator 12 is often offset to an edge of the coarse actuator 11 during a normal tracking operation. This reduces the space made available for the fine actuator 12 to perform track seeking and quite often results in a failure of the track seeking operation. If the track seeking operation fails, another track seeking operation must be performed and this increases the time required to lock onto the target track and lowers the overall efficiency of the optical drive. Accordingly, reducing the frequency of track seeking failures in an optical drive to thereby increase overall efficiency is a problem of great interest to the optical drive industry.

### SUMMARY OF THE INVENTION

One objective of the claimed invention is therefore to provide a method of auxiliary track seeking in an optical drive, to solve the above-mentioned problem by controlling a DC motor to output a coarse actuator signal to a coarse drive circuit to push the coarse actuator. The deviation signal corresponding to the relative offset between the position of the fine actuator and the position of the coarse actuator is maintained within a deviation signal threshold range. Before the optical drive performs a track seeking operation, the corresponding positions of the fine actuator and the coarse actuator are maintained in suitable positions in the direction of the track seeking operation. In this way, track seeking failures are reduced.

Another objective of the claimed invention is to provide a method of auxiliary track seeking in an optical drive, to solve the above-mentioned problem by counting a number of times of pushing the coarse actuator. When the number of times is equal to a first predetermined value, the amplitude of a fixed value coarse actuator signal is increased. Due to the different mechanics of different optical drives, the speed of adjustment of the relative positions between the fine actuator and the coarse actuator to achieve a suitable track seeking position is also increased, thereby increasing overall efficiency.

According to an exemplary embodiment of the claimed invention, before performing a track seeking operation in an optical drive, a coarse actuator signal outputted to a coarse actuator drive circuit is utilized for controlling a direct current (DC) motor to push the coarse actuator. By adjusting a positional deviation signal corresponding to relative positions of a fine actuator and the coarse actuator to become within a predetermined deviation threshold range, the corresponding positions of the fine actuator and the coarse actuator are made to maintain a fixed distance while track seeking in a particular direction. This allows the optical drive to avoid a failure of the track seeking operation due to the fine actuator being at the edge of the coarse actuator when performing track seeking operations.

According to another exemplary embodiment of the claimed invention, a method of auxiliary track seeking in an optical drive is disclosed. The method comprises the following steps: (a) detecting a deviation signal corresponding to a positional difference between a fine actuator and a coarse actuator; (b) comparing a value of the deviation signal with a deviation signal value range threshold to thereby determine if the deviation signal value exceeds the deviation signal value range threshold; and if the deviation signal value exceeds the deviation signal value range threshold: (c) exerting a voltage pulse to push the coarse actuator and thereby adjust the deviation signal toward the deviation signal value range threshold; and (d) repeating the above steps.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of how a conventional optical drive controls a fine actuator and a coarse actuator according to the related art.

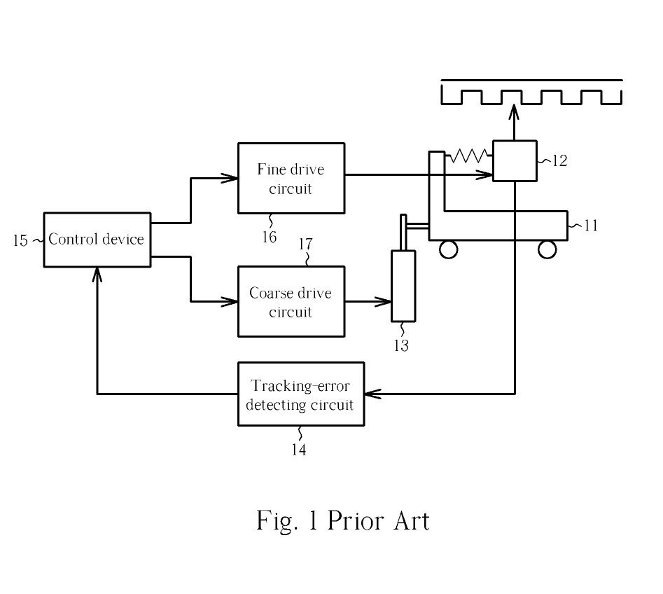

FIG. 2 shows a block diagram of components in an optical drive for performing an auxiliary track seeking method according to an exemplary embodiment of the present invention.

FIG. 3, shows a graph of the displacement of the fine actuator relative to the center position of the coarse actuator when detecting the positional deviation signal of FIG. 2.

FIG. 4 shows a flowchart of a method of auxiliary track seeking according to a first exemplary embodiment of the present invention.

FIG. 5 shows a flowchart of a method of auxiliary track seeking according to a second exemplary embodiment of the present invention.

FIG. 6 shows a flowchart of a method of auxiliary track seeking according to a third exemplary embodiment of the present invention.

### DETAILED DESCRIPTION

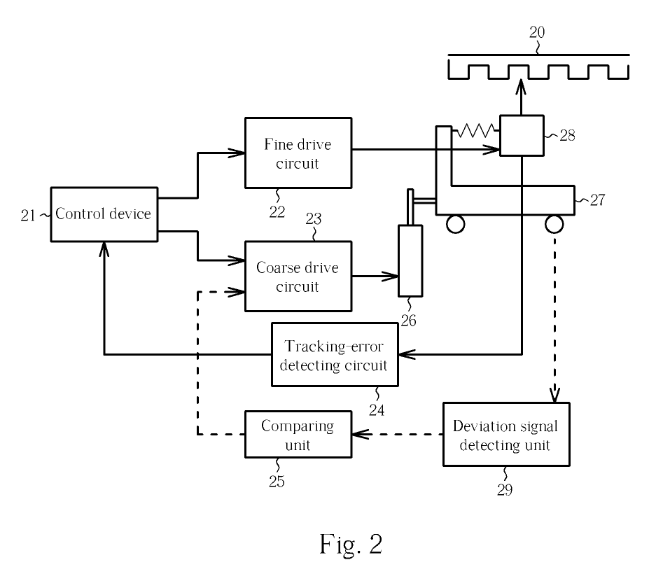

Please refer to FIG. 2 showing a block diagram of components in an optical drive for performing an auxiliary track seeking method according to an exemplary embodiment of the present invention. As shown in FIG. 2, the optical drive includes a control device 21, a fine drive circuit 22, a coarse drive circuit 23, a tracking-error detecting unit 24, a comparing unit 25, a direct current (DC) motor 26, a coarse actuator 27, a fine actuator 28, and a deviation signal detecting unit 29. According to the tracking error signal detected by the tracking-error detection unit 24, the control device 21 controls the movement of the coarse actuator 28 to follow and lock onto a data track of an optical disc 20. The deviation signal detecting unit 29 generates a deviation signal by detecting relative positions of the coarse actuator 27 and the fine actuator 28, and outputs the deviation signal to the comparing unit 25 for comparison. The output of the comparing unit 25 forms a driving signal, which is inputted to the coarse drive circuit 23. In this way, the coarse drive circuit 23 drives the DC motor 26 to push the coarse actuator 27, moving the fine actuator 28 toward the center of the coarse actuator 27 and maintaining the deviation signal corresponding to the relative positions of the fine actuator 28 and the coarse actuator 27 within a predetermined threshold range to ensure the fine actuator 28 leaves the edge of the coarse actuator 27.

Therefore, before switching from a tracking state to a track seeking state in the auxiliary track seeking method of the present invention, the control device 21 controls the movement of the fine actuator 28 to maintain tracking and lock onto a data track of the optical disc 20, and controls the coarse drive circuit 23 to form an open loop. This allows the loop formed by the deviation signal detecting unit 29 and the comparing unit 25 to control the coarse drive circuit 23. The comparing unit 25 compares the amplitude and direction of the deviation signal corresponding to the detected fine actuator 28 and the coarse actuator 27 relative positions detected by the deviation signal detection unit 29 to form a drive signal to control the coarse drive circuit 23. A voltage pulse is outputted to drive the DC motor 26 to push the coarse actuator 27 in order to make the fine actuator 28 move toward the center of the coarse actuator 27. The deviation signal corresponding to the relative positions is adjusted to be within a predetermined threshold range to thereby reduce track seeking failures.

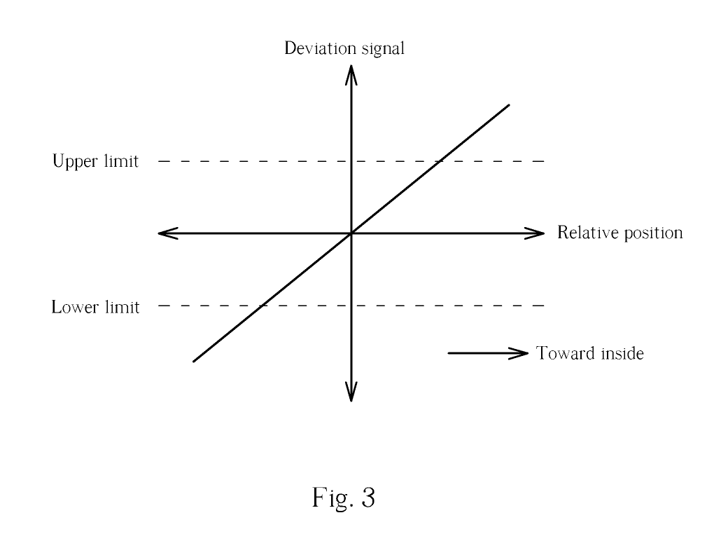

The positional deviation signal is detected by the deviation signal detecting unit 29 in the following manner. In one embodiment, utilizing the center of the coarse actuator 27 as a reference, the direction facing toward an inner edge of the optical disc 20 is defined as positive and the direction facing toward an outer edge of the optical disc is defined as negative. As shown in FIG. 3, the larger the displacement of the fine actuator 28 relative to the center position of the coarse actuator 27, the larger the deviation signal. Also, by detecting how far the fine actuator 28 can be positioned away from the center of the coarse actuator 27 while still being capable of safely receiving a control signal, an upper and lower limit of the deviation signal threshold can be determined.

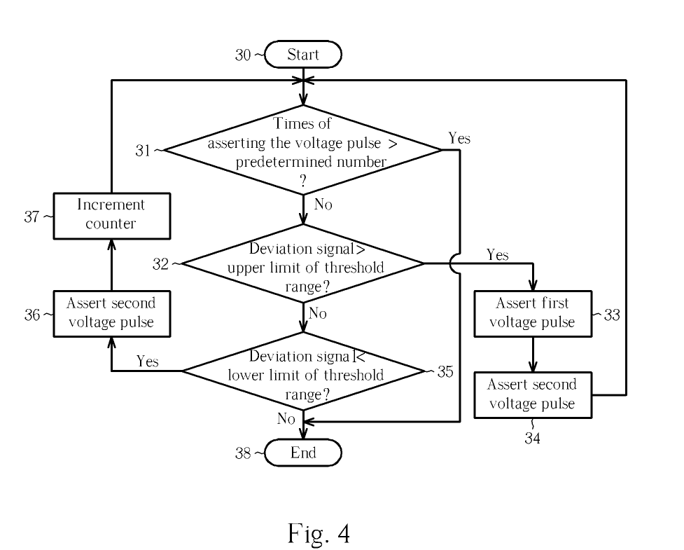

FIG. 4 shows a flowchart of a method of auxiliary track seeking according to a first exemplary embodiment of the present invention. Referring to the components indicated in FIG. 2, the auxiliary track seeking method according to this embodiment of the present invention includes the following steps:

Step 30: Start performing an auxiliary track seeking operation.

Step 31: Check if the number of times of exerting the voltage pulse is greater than a predetermined number. If yes, proceed to step 38; otherwise, proceed to step 32.

Step 32: Compare the positions of the fine actuator 28 and the coarse actuator 27. Check if the deviation signal detected by the deviation signal detecting unit 29 is greater than an upper limit of a predetermined deviation threshold range. If yes, proceed to step 33; otherwise proceed to step 35.

Step 33: Exert a first voltage pulse pushing the coarse actuator 27 to make a correction toward the inner direction thereby reducing the value of the deviation signal.

Step 34: count a counter for accumulating the number of times the voltage pulse has been exerted. Afterwards, return to step 31 to repeat the operations.

Step 35: Check if the deviation signal is less than a lower limit of the predetermined deviation threshold range. If yes, proceed to step 36; otherwise proceed to step 38.

Step 36: Exert a second voltage pulse pushing the coarse actuator 27 to make a correction toward the outer direction thereby increasing the value of the deviation signal.

Step 37: Count a counter for accumulating the number of times the voltage pulse has been exerted. Afterwards, return to step 31 to repeat the operations.

Step 38: Reset the counter for accumulating the number of times the voltage pulse has been exerted back to a value of zero and end the optical drive track seeking operation.

According to the above-described steps, in this embodiment, before the optical drive performs a track seeking operation, the auxiliary track seeking method of the present invention is utilized. Firstly, the relative positions of the fine actuator 28 and the coarse actuator 27 are detected to determine if they are located at a suitable track position. If they are not located at a suitable track position, next output a first or a second voltage pulse to the coarse drive circuit 23 according to an upper limit and a lower limit of a threshold range. In this way, the DC motor 26 pushes the coarse actuator 27 toward an inner or an outer direction, which thereby moves the deviation signal value corresponding to the relative positions of the fine actuator 28 and the coarse actuator 27 into the predetermined deviation range. The relative positions of the fine actuator 28 and the coarse actuator 27 are in this way maintained at a suitable distance in the direction of the track seeking operation. When the optical drive switches to perform the track seeking operation, optical drive track seeking failures are reduced. In the above-described process, a length of time or an amplitude of the first or the second voltage pulses can be predetermined as fixed or variable values. Additionally, in order to overcome differences between the mechanics of different optical drives or differences in the precision of the control device 21 which may result in the voltage pulses not being able to ensure the deviation signal value returns to within the predetermined deviation signal range and repeated deficient applications, the present invention employs a preset upper limit of the number times the voltage pulse will be exerted. If the upper limit is exceeded, the optical drive will abort the auxiliary track seeking operation and directly enter the track seeking state.

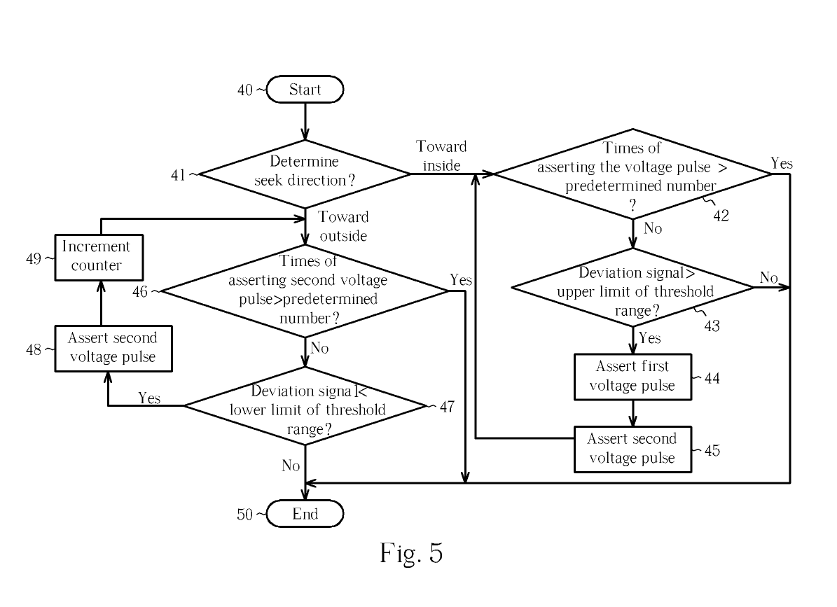

FIG. 5 shows a flowchart of a method of auxiliary track seeking according to a second exemplary embodiment of the present invention. The second embodiment is very similar to the first embodiment with a difference between the first embodiment and this embodiment being that this embodiment further accounts for the track seeking direction of the optical drive track seeking operation. Firstly, a determination is made of whether the deviation detected by the deviation signal detecting unit 29 is in the same direction. This information is utilized to decide if it is necessary to perform the above-described operations to adjust the position of the fine actuator by making the fine actuator 28 move toward the center of the coarse actuator 27. This reduces any unnecessary adjustment operation time, and increases the overall optical drive efficiency. The auxiliary track seeking method according to this embodiment of the present invention includes the following steps:

Step 40: Start performing an auxiliary track seeking operation.

Step 41: Determine the seek direction for the target track for the tracking seeking operation. If the seek direction is towards the inner edge of the optical disc 20 then proceed to step 42; otherwise, proceed to step 46.

Step 42: Check if the number of times of exerting a first voltage pulse is greater than a predetermined number. If yes, proceed to step 50; otherwise, proceed to step 43.

Step 43: Compare the positions of the fine actuator 28 and the coarse actuator 27 to check if the deviation signal detected by the deviation signal detecting unit 29 is greater than an upper limit of a predetermined deviation threshold range. If yes, proceed to step 44; otherwise proceed to step 50.

Step 44: Exert the first voltage pulse to push the coarse actuator 27 to make a correction toward the inner direction thereby reducing the value of the deviation signal.

Step 45: Count the counter for accumulating the number of times the first voltage pulse has been exerted. Afterwards, return to step 42 to repeat the operations.

Step 46: Check if the number of times of exerting a second voltage pulse is greater than a predetermined number. If yes, proceed to step 50; otherwise, proceed to step 47.

Step 47: Check if the deviation signal is less than a lower limit of the predetermined deviation threshold range. If yes, proceed to step 48; otherwise proceed to step 50.

Step 48: Exert the second voltage pulse to push the coarse actuator 27 to make a correction toward the outer direction thereby increasing the value of the deviation signal.

Step 49: Count the counter for accumulating the number of times the second voltage pulse has been exerted. Afterwards, return to step 46 to repeat the operations.

Step 50: Reset the counter for accumulating the number of times the voltage pulses have been exerted back to a value of zero and end the optical drive track seeking operation.

The auxiliary track seeking method of this embodiment involves comparing the directions of the optical drive track seek operation and the positional deviation. For example, again referring to FIG. 3, when the optical drive track seeking direction is toward an outer edge of the optical disc 20 and the positional deviation signal is a positive value, the fine actuator 28 is located near an inner edge of the coarse actuator 27. Because the directions are opposite, even though the fine actuator 28 is not within the threshold range of the coarse actuator 27, there is already maintained a large track seeking space from one end of the coarse actuator 27 to the other end of the coarse actuator 27. Therefore, it is not necessary to perform the adjustment operation to move the fine actuator 28 toward the center of the coarse actuator 27. In this way, the adjustment operation is thereby simplified and the overall efficiency of the optical drive is further increased.

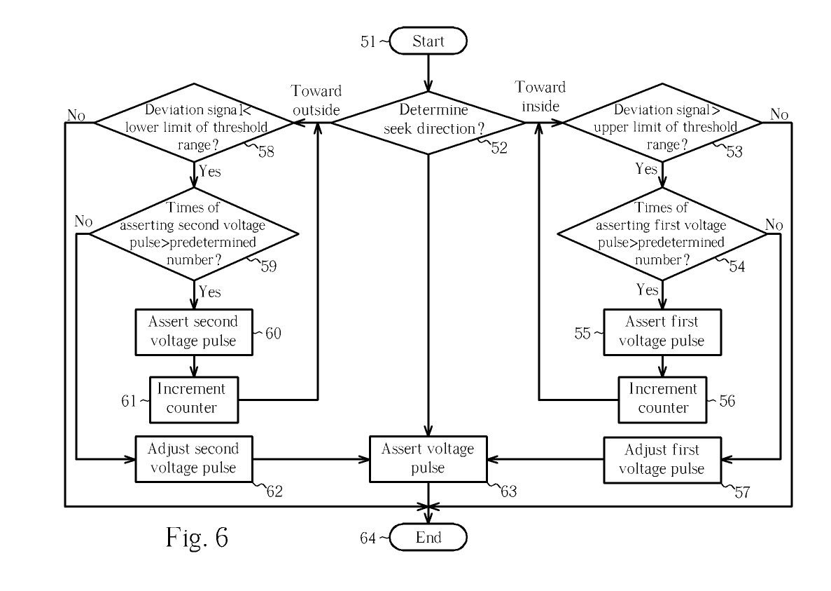

Continuing, please refer to FIG. 6 showing a flowchart of a method of auxiliary track seeking according to a third exemplary embodiment of the present invention. The third embodiment is very similar to the first and second embodiments with a difference between the previous embodiments and this embodiment being that in this embodiment a situation where deficient applications of the voltage pulses are unable to (or are too slow to) adjust the deviation signal value to return to within the predetermined threshold range due to optical drive mechanics differences or control device precision is avoided. In advance, a predetermined number of times of exerting the voltage pulse being unable to make the deviation signal return to within the predetermined threshold range is determined. The voltage pulse is increased to make the relative positions of the fine actuator 28 and the coarse actuator 27 more quickly enter suitable track seeking positions. In this way, the speed of the adjustment operation is increased. The auxiliary track seeking method according to this embodiment of the present invention includes the following steps:

Step 51: Start performing an auxiliary track seeking operation.

Step 52: Determine the seek direction of the target track for the track seeking operation. If the seek direction is towards the inner edge of the optical disc 20 then proceed to step 53; otherwise, if the seek direction is towards the outer edge then proceed to step 58.

Step 53: Compare the positions of the fine actuator 28 and the coarse actuator 27 to check if the deviation signal detected by the deviation signal detecting unit 29 is greater than an upper limit of a predetermined deviation threshold range. If yes, proceed to step 54; otherwise proceed to step 64.

Step 54: Check if the number of times of exerting a first voltage pulse is less than a predetermined number. If yes, proceed to step 55; otherwise, proceed to step 57.

Step 55: Exert the first voltage pulse to push the coarse actuator 27 to make a correction toward the inner direction thereby reducing the value of the deviation signal.

Step 56: Count the counter for accumulating the number of times the first voltage pulse has been exerted. Afterwards, return to step 53 to repeat the operation.

Step 57: Appropriately adjust the first voltage pulse. For example increase the amplitude or the time in order to overcome mechanical differences and increase the efficiency of lowering the deviation signal value. Afterwards, proceed to step 63.

Step 58: Compare the positions of the fine actuator 28 and the coarse actuator 27 to check if the deviation signal detected by the deviation signal detecting unit 29 is less than a lower limit of a predetermined deviation threshold range. If yes, proceed to step 59; otherwise proceed to step 64.

Step 59: Check if the number of times of exerting the second voltage pulse is less than a predetermined number. If yes, proceed to step 60; otherwise, proceed to step 62.

Step 60: Exert the second voltage pulse to push the coarse actuator 27 to make a correction toward the outer direction thereby increasing the value of the deviation signal.

Step 61: Count the counter for accumulating the number of times the second voltage pulse has been exerted. Afterwards, return to step 58 to repeat the operation.

Step 62: Appropriately adjust the second voltage pulse. For example increase the amplitude or the time in order to overcome mechanical differences and increase the efficiency of raising the deviation signal value.

Step 63: After being adjusted, the voltage pulse pushes the coarse actuator 27 to perform a correction.

Step 64: Reset the counter for accumulating the number of times the voltage pulses have been exerted back to a value of zero and end the optical drive track seeking operation.

This embodiment can record the number of times of exerting the voltage pulse when adjusting the deviation signal of the fine actuator and the coarse actuator. If the number of times reaches a predetermined value and it is still not able to drive the deviation signal to return to within the predetermined deviation signal value threshold range, then the voltage pulse is adjusted. For example, the amplitude of the voltage pulse is increased or a duration time of the voltage pulse is increased. In this way, the coarse actuator 27 is pushed to thereby perform an adjustment correction. Examples of increasing the voltage pulse include increasing the amplitude or time duration by a factor of two or three times the original (2×, 3×, etc). The amount of the increase could either be fixed or variable. In this way, the speed of adjusting the relative positions of the fine actuator and the coarse actuator is greatly increased along with the speed of the auxiliary track seeking operation. That is, overall efficiency of the optical drive is increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of auxiliary track seeking in an optical drive, the method comprising the following steps:
(a) detecting a deviation signal corresponding to a positional difference between a fine actuator and a coarse actuator;
(b) comparing a value of the deviation signal with a deviation signal value range threshold to thereby determine if the deviation signal value exceeds the deviation signal value range threshold, performing step (c) if the deviation signal value exceeds the deviation signal value range threshold, and performing step (e) if not:
(c) exerting a voltage pulse to push the coarse actuator and thereby adjust the deviation signal toward the deviation signal value range threshold; and
(d) repeating the above steps;
(e) ending the auxiliary track seeking.

2. The method of claim 1, further comprising if the deviation signal value is greater than an upper limit of the deviation signal value range threshold in step (b), exerting a first voltage pulse to push the coarse actuator in step (c).

3. The method of claim 2, further comprising if the deviation signal value is greater than a lower limit of the deviation signal value range threshold in step (b), exerting a second voltage pulse to push the coarse actuator in step (c).

4. The method of claim 3, wherein the first voltage pulse and second voltage pulse are opposites.

5. The method of claim 1, wherein in step (c), a time, an amplitude, or a duration of the voltage pulse is a predetermined value, a fixed value, or a variable value.

6. The method of claim 1, wherein in step (b), the deviation signal range threshold includes an upper limit and a lower limit defined corresponding to a distance of the fine actuator from the center of the coarse actuator allowing the fine actuator to safely receive a signal.

7. The method of claim 1, further comprising the following step after step (a):
(a-1) checking if a number of times of exerting the voltage pulse is greater than a predetermined number, performing step (e) if yes, and then performing step (c) if not; and
further comprising the following step after step (c):
(c-1) counting a counter for accumulating a number of times the voltage pulse has been exerted.

8. The method of claim 7, further comprising resetting the counter back to zero before ending auxiliary track seeking.

9. The method of claim 1, further comprising the following step after step (a):
(a-1) determining a track seek direction according to an inner edge or an outer edge of an optical disc in the optical drive.

10. The method of claim 9, wherein when the track seeking direction is toward the inner edge of the optical disc, comparing the value of the deviation signal with a upper limit of the deviation signal value range threshold in step (b).

11. The method of claim 9, wherein when the track seeking direction is toward the outer edge of the optical disc, comparing the value of the deviation signal with an lower limit of the deviation signal value range threshold in step (b).

12. The method of claim 1, wherein in step (b) before performing step (c), further comprising:
(b-1) checking if a number of times of exerting the voltage pulse is less than a predetermined number, if yes then performing step (c), and if not then adjusting the voltage pulse before ending the track seeking; and
further comprising the following step after step (c):
(c-1) counting a counter for accumulating a number of times the voltage pulse has been exerted.

13. The method of claim 12, wherein an amount of adjustment of the voltage pulse is a fixed amount, a predetermined amount, or a variable amount.

14. The method of claim 12, wherein adjusting the voltage pulse comprises adjusting an amplitude or a time duration of the voltage pulse.

15. The method of claim 12, further comprising resetting the counter back to zero before ending auxiliary track seeking.
